(19) United States
(12) Patent Application Publication
(10) Pub. No.: US 2021/0152939 A1
(43) Pub. Date: May 20, 2021

(54) AUDIO SYSTEM SPEAKER VIRTUALIZATION

(71) Applicant: Analog Devices, Inc., Norwood, MA (US)

(72) Inventors: Boris LERNER, Sharon, MA (US); Robert ADAMS, Acton, MA (US); Christopher HANNA, Arlington, MA (US); Kenneth MALSKY, Bedford, MA (US); Philip Gregory GEERLING, Saint Louis, MO (US); Alan Peter NORTON, West Bloomfield, MI (US); Andre VAN SCHYNDEL, Kanata (CA)

(73) Assignee: Analog Devices, Inc., Norwood, MA (US)

(21) Appl. No.: 16/688,765

(22) Filed: Nov. 19, 2019

(51) Int. Cl. H04R 5/02; G06F 3/16; H04S 7/00; H04R 27/00; H04R 3/12

(52) U.S. Cl. CPC H04R 5/02; G06F 3/165; H04S 7/301; H04S 2400/01; H04R 3/12; H04S 7/308; H04S 2420/01; H04R 27/00

(57) ABSTRACT

Embodiments may relate to an audio system for playback of an audio signal, for example in a motor vehicle. The audio system may include a virtualization speaker located in a position that would be in front of a listener of the audio system. The audio system may further include a user speaker located in a position that would be behind a listener of the audio system. In some embodiments the virtualization speaker may be configured to play a virtualization audio signal while the user speakers are configured to play an audio signal which at least partially overlaps the virtualization audio signal. In some embodiments the virtualization audio signal may be at a different volume or a different frequency range than the audio signal. Other embodiments may be described or claimed.

### FIELD OF THE DISCLOSURE

Embodiments herein relate to an audio system, and more particularly, to an audio system with front-speaker virtualization.

### BACKGROUND

In future motor vehicles such as cars, trucks, vans, etc., it may be desirable for audio systems to include individual audio zones for the occupants of the motor vehicles. Additionally, it may be desirable for the internal configuration (e.g, the seating configuration) of the motor vehicles to be adjustable. As a result, it may be desirable for speakers to be built into individual seats of the motor vehicles.

### BRIEF DESCRIPTION OF THE DRAWINGS

FIG. 1 depicts one example configuration of a motor vehicle with an audio system that includes a virtualization speaker, in accordance with various embodiments.

FIG. 2 depicts an alternative example configuration of a motor vehicle with an audio system that includes a virtualization speaker, in accordance with various embodiments.

FIG. 3 depicts an alternative example configuration of a motor vehicle with an audio system that includes a virtualization speaker, in accordance with various embodiments.

FIG. 4 depicts an example technique which may be used in or by an audio system with a virtualization speaker, in accordance with various embodiments.

FIG. 5 depicts another technique which may be used in or by an audio system with a virtualization speaker, in accordance with various embodiments.

FIG. 6 is a block diagram of an example electrical device that may be used in an audio system with a virtualization speaker, in accordance with various embodiments.

### SUMMARY OF THE DISCLOSURE

Embodiments may relate to an audio system for playback of an audio signal, for example in a motor vehicle. The audio system may include a virtualization speaker located in a position that would be in front of a listener of the audio system. The audio system may further include a user speaker located in a position that would be behind a listener of the audio system. In some embodiments the virtualization speaker may be configured to play a virtualization audio signal while the user speakers are configured to play an audio signal which at least partially overlaps the virtualization audio signal. In some embodiments the virtualization audio signal may be at a different volume or a different frequency range than the audio signal. Other embodiments may be described or claimed.

One embodiment may include an audio system for playback of an audio signal, wherein the audio system comprises: a virtualization speaker located in a position that would be in front of a listener of the audio system; a user speaker located in a position that would be behind a listener of the audio system; and a processor coupled with the virtualization speaker and the user speaker, wherein the processor is to: identify a stereo signal that is to be played by the user speaker; process the stereo signal to generate a processed stereo signal; and begin playback of the processed stereo signal from the virtualization speaker prior to beginning playback of the stereo signal from the user speaker.

Another embodiment may include a motor vehicle with an audio system, wherein the audio system includes: a first user speaker located in a position that would be behind a first occupant of the motor vehicle, wherein the first user speaker is to play a first audio signal; a second user speaker located in a position that would be behind a second occupant of the motor vehicle, wherein the second user speaker is to play a second audio signal; and a virtualization speaker located in a position that would be in front of the first occupant and the second occupant, wherein the virtualization speaker is to: play a first processed audio signal that is related to the first audio signal; and play a second processed audio signal that is related to the second audio signal; wherein playback of the first processed audio signal at least partially overlaps playback of the second processed audio signal.

Another embodiment may include one or more non-transitory computer-readable media comprising instructions that, upon execution by a processor of an audio system of a motor vehicle, are to cause the processor to: identify a stereo signal that is to be played by a user speaker at a location behind an occupant of the motor vehicle; perform high-pass filtering of the stereo signal to generate a processed stereo signal; begin playback of the processed stereo signal from a virtualization speaker at a location in front of an occupant of the motor vehicle; and subsequent to beginning playback of the processed stereo signal, begin playback of the stereo signal from the user speaker.

### DETAILED DESCRIPTION

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense.

For the purposes of the present disclosure, the phrase “A or B” means (A), (B), or (A and B). For the purposes of the present disclosure, the phrase “A, B, or C” means (A), (B), (C), (A and B), (A and C), (B and C), or (A, B and C).

The description may use perspective-based descriptions such as front/back, left/right, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Various operations may be described as multiple discrete operations in turn, in a manner that is most helpful in understanding the claimed subject matter. However, the order of description should not be construed as to imply that these operations are necessarily order dependent.

As previously noted, in future motor vehicles, it may be desirable for speakers to be built into individual seats of the motor vehicles. However, humans generally prefer that their audio come from in front of them. Therefore, it may be desirable for some sort of speaker virtualization to be implemented, where the speaker virtualization may move the perceived audio from behind the user to in front of them.

Generally, embodiments herein may be described with respect to motor vehicles such as cars, however it will be understood that embodiments of the present disclosure may be implemented in, or otherwise be a part of, other types of motor vehicles such as trucks, vans, etc. Similarly, embodiments may be implemented in, or otherwise be a part of, other types of motor vehicles such as boats, airplanes, helicopters, etc. Embodiments may likewise be implemented in, or otherwise be a part of, other configurations where media or an audio signal might be consumed such as a home theater configuration, a commercial theater, or some other user case where speakers may be placed behind a user who may desire the audio to come from in front of them.

Generally, embodiments herein may relate to a psycho-acoustic approach, which may have characteristics similar to those of the Haas audio effect. Generally, the Haas audio effect indicates that if a similar sound is played from two separate sources, and one of those sources is delayed with respect to the other using a delay that is small enough to be imperceptible to most humans (e.g., on the order of less than 40 milliseconds (ms)), then a human user (who may also be referred to as a “listener” or an “occupant of the motor vehicle”) may perceive the entire sound coming from the source of the first arrival. Embodiments herein relate to the use of this effect to move the perception of the sound from the rear speakers (herein referred to as “user speakers”) to in front of the user by placing a front speaker (herein referred to as a “virtualization speaker”) in front of the user. In some embodiments, the sound from the virtualization speaker may only be a portion of the sound played by the user speakers, e.g. only the high-frequency portion of the audio played by the user speakers. In some embodiments the sound played by the user speakers may be delayed by a small amount (e.g., on the order of less than 40 ms) with respect to the sound played by the virtualization speaker. In some embodiments, the sound played by the virtualization speaker may be quieter than the sound played by the user speakers. As a result, the sound may be perceived by the user as coming from in front of the user.

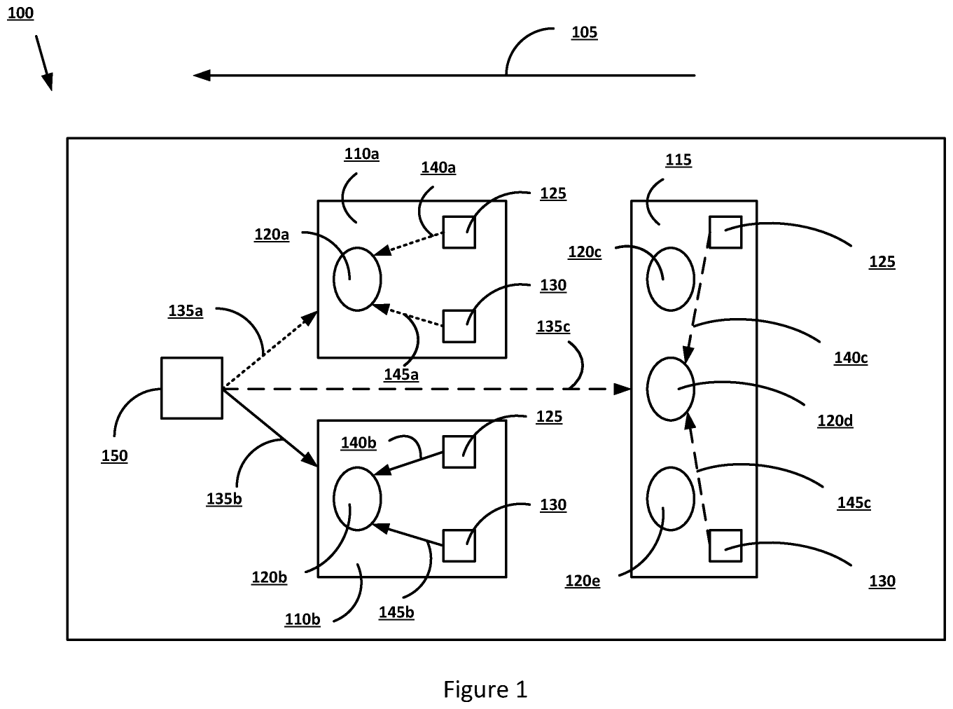

FIGS. 1-3 depict example configurations of a motor vehicle with an audio system that includes a virtualization speaker, in accordance with various embodiments. It will be understood that these configurations are intended as non-exhaustive examples of various configurations which may be used, and other embodiments may vary from those shown, or may have combinations of elements from various of the Figures. For example, although the Figures show example locations of various seats, passengers, speakers, sound paths, etc. other embodiments may have more or fewer elements than depicted in the Figures, elements in a different configuration than depicted, passengers facing in a different direction than depicted, etc. Additionally, it will be understood that, unless specifically stated otherwise, the specific sizes, shapes, distances, etc. of the various Figures may not accurately reflect real-world embodiments, rather the elements of the Figures are intended to illustrate concepts of this disclosure.

Turning to FIG. 1, FIG. 1 depicts a motor vehicle 100. As described above, the motor vehicle may be a car, a truck, a van, or some other type of motor vehicle. For the sake of discussion of the various Figures, a car will be used as a descriptive embodiment. Generally, the motor vehicle will be oriented as indicated by the arrow 105. That is, passengers of the motor vehicle may be generally all facing towards the left side of the page with respect to the orientation of FIG. 1. The motor vehicle 100 may include two front seats 110a and 110b (collectively referred to as “front seats” 110). The motor vehicle may further include a back seat 115. A number of passengers 120a, 120b, 120c, 120d, and 120e (collectively referred to as “passengers” 120) may be present in the motor vehicle, and particularly may be present in the front seats 110 or the back seat 115.

Respective ones of the seats 110 and 115 may include a right user speaker 125 and a left user speaker 130 which may be generally positioned behind, and to the right or left of, the passengers 120. Specifically, each of the front seats 110a and 110b may include an individual right user speaker 125 and left user speaker 130. By contrast, the back seat 115 may have a single right user speaker 125 which is located to the right of passengers 120c, 120d, and 120e. Similarly, the back seat 115 may have a single left user speaker 125 which is located to the left of passengers 120c, 120d, and 120e. However, as noted above it will be understood that this is one example configuration for the sake of discussion and in other embodiments the back seat 115 may include additional right or left user speakers, the back seat 115 may be replaced by individual seats for one or more of the passengers 120c, 120d, or 120e, etc.

Respective ones of the right user speakers 125 may output a right audio signal such as right audio signals 140a, 140b, and 140c (referred to collectively as “right audio signals 140”). Similarly, respective ones of the left user speakers 125 may output a left audio signal such as left audio signals 145a, 145b, and 145c (referred to collectively as “left audio signals 145”). Generally, the right and left audio signals 140 and 145 may be the right and left elements of a stereo signal (e.g., the right and left channels), the entire signal (e.g., if the signal does not include separate right and left channels), or some other type of audio signal.

The motor vehicle 100 may further include a virtualization speaker 150. As used herein, the term “virtualization speaker” may refer to a physical speaker that is configured to play a virtualization audio signal. Generally, the virtualization speaker 150 may be located near the front of the motor vehicle 100 and, more specifically, the virtualization speaker 150 may be located in front of the passengers 120 of the motor vehicle as shown in FIG. 1. As used herein, the “virtualization audio signal” may refer to an audio signal that is played by a virtualization speaker such as virtualization speaker 150. The virtualization audio signal may rely on the effect described above which is similar to the Haas effect and, in conjunction with the right and left audio signals 140/145, cause a passenger 120 to perceive that the entire audio signal is coming from in front of them rather than from the right and left user speakers 125/130 that are located behind them. As shown in FIG. 1, the virtualization speaker 150 may be configured to play a number of virtualization audio signals 135a, 135b, and 135c (collectively referred to herein as “virtualization audio signals 135”).

In some embodiments the virtualization audio signal may be similar, or identical to, one or both of the right and left audio signals. For the sake of discussing various examples, the audio signal consisting of virtualization audio signal 135a, right audio signal 140a, and left audio signal 145a will be discussed, however it will be understood that others of the audio signals may likewise have similarities or differences.

As one example, if right audio signal 140a is identical to left audio signal 145a, then the virtualization audio signal 135a may be similar to or identical to the right and left audio signals 140a/145a. Alternatively, if right and left audio signals 140a/145a are separate channels of a stereo signal, then the virtualization audio signal 135a may be a signal that combines the two channels into a single audio signal.

In some embodiments, the virtualization audio signal 135a may be different than one or both of the right and left audio signals 140a and 145a. For example, in some embodiments the virtualization audio signal 135a may be quieter than one or both of the right and left audio signals 140a and 145a. Specifically, the virtualization speaker 150 may emit the virtualization audio signal 135a at a lower volume that the right and left audio signals 140a and 145a are emitted by the right and left user speakers 125 and 130. In other embodiments, the audio path of the virtualization audio signal 135a may be longer than the audio path of the right and left audio signals 140a and 145a, and so fading occur. In some embodiments, the virtualization speaker 150 may emit the virtualization audio signal 135a at a volume at or above the level at which the right and left audio signals are emitted, but due to fading the virtualization audio signal 135a may arrive at the user 120a at a level below the level at which the right and left audio signals 140a and 145a arrive at the user.

Additionally or alternatively, the virtualization audio signal 135a may include only the high-frequency elements of one or both of the right and left audio signals 140a and 145a. For example, in some embodiments the virtualization audio signal 135a may include only frequencies of one or both of the right and left audio signals 140a and 145a above approximately 1 kilohertz (kHz). In this embodiment, the virtualization audio signal 135a could be generated by passing one or both of the right and left audio signals 140a and 145a through a high-pass filter or some other mechanism which may isolate the frequencies above approximately 1 kHz.

Additionally or alternatively, in some embodiments the right and left audio signals 140a and 145a may be time-delayed with respect to the virtualization audio signal 135a. For example, the virtualization audio signal 135a may begin playback a relatively small time period before playback of the right and left audio signals 140a and 145a begin. The time period may be such that it may be imperceptible to the passenger 120a, as described above. In some embodiments, the time period may be less than approximately 40 ms. In some embodiments, the time period may be on the order of between approximately 5 and approximately 10 ms. In some embodiments, the sound path of the right and left audio signals 140a and 145a may be longer or shorter than the sound path of the virtualization audio signal 135a, and so the right and left audio signals 140a and 145a may be delayed an amount that results in them arriving at the passenger 120a between approximately 5 and approximately 10 ms after the arrival of the virtualization audio signal 135a.

In these cases, playback of the virtualization audio signal 135a and playback of the right and left audio signals 140a and 145a may generally overlap, but a portion (e.g., a particular time-stamp of the audio file) of the virtualization audio signal 135a may reach the passenger 120a before the same portion of the right and left audio signals 140a and 145a reaches the passenger 120a. In this case, the passenger 120a may hear the portion coming from the virtualization audio signal 135a before the passenger 120a hears the same portion coming from the right and left audio signals 140a and 145a, so the passenger 120a may perceive the entire audio signal as coming from the virtualization audio signal 135a (e.g., in front of them) rather than from the right and left user speakers 125 and 130.

In some embodiments, and as shown in FIG. 1, it may be possible for different passengers of the motor vehicle 100 to listen to different audio signals simultaneously. In FIG. 1, the different audio signals are depicted using arrows with different dash patterns. As one example, passenger 120a may be listening to a certain song, while passenger 120b is listening to a different song entirely. Referring to FIG. 1, virtualization audio signal 135a, right audio signal 140a, and left audio signal 145a may all be audio signals relating to one specific song or other type of audio. Similarly, virtualization audio signal 135b, right audio signal 140b, and left audio signal 145b may all be audio signals relating to another specific song or other type of audio. Finally, virtualization audio signal 135c, right audio signal 140c, and left audio signal 145c may all be audio signals relating to another specific song or other type of audio. Because the virtualization audio signals 135 may be relatively quiet as compared to the right and left audio signals 140 and 145, or may only contain high-frequency portions of the right and left audio signals 140 and 145, multiple virtualization audio signals 135 may be played by the virtualization speaker 150 at least partially concurrently with one another. In this way, multiple passengers 120 may be able to listen to different audio signals from the various right and left user speakers 125 and 130, while each passenger 120 may perceive the audio signals as coming from in front of them with respect to the orientation 105 of the motor vehicle 100.

It will be recognized that in the discussion above, various operations related to playback are described with respect to elements such as the virtualization speaker 150 or the various right and left user speakers 125 and 130. The motor vehicle 100 may include one or more processors that are communicatively coupled with the various speakers. The processor(s) may be a single or multi-cored processor, a processing core of a multi-cored processor, a central processing unit (CPU), etc. The processor is not depicted in FIG. 1 for the sake of elimination of clutter of the Figure. However, the processor may be configured to perform one or more of the operations discussed above such as high-pass filtering, time-delayed playback, volume adjustment, or facilitating playback of one or more of the audio signals from one or more of the speakers 125/130/150 discussed herein.

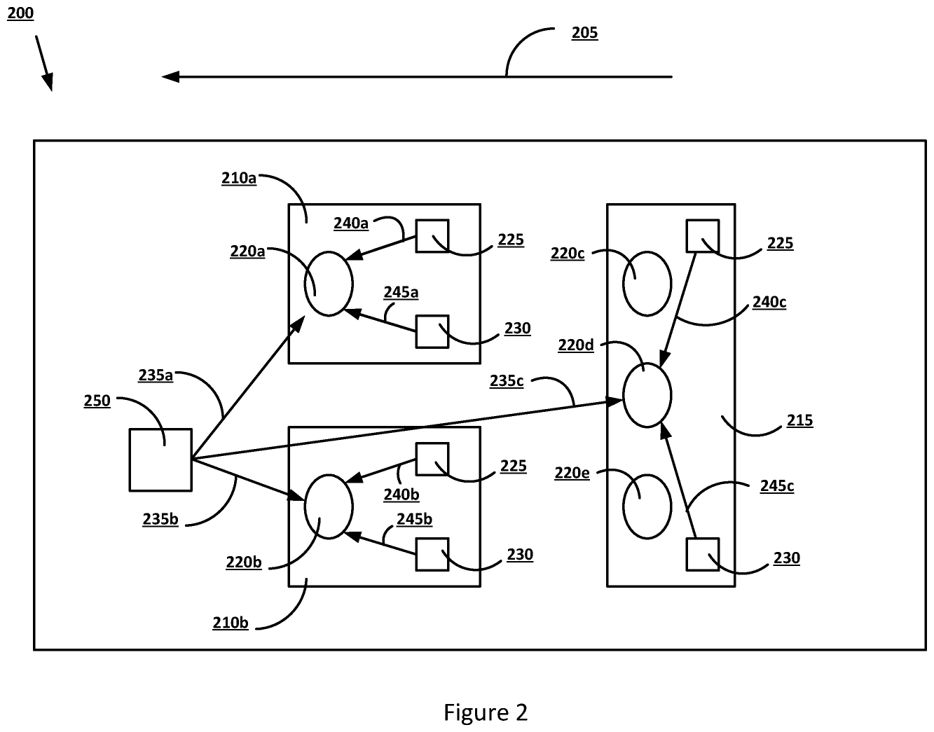

FIG. 2 depicts an alternative example configuration of a motor vehicle with an audio system that includes a virtualization speaker, in accordance with various embodiments. Generally, the motor vehicle 200 may be similar to, and share one or more characteristics with, motor vehicle 100. Specifically, the motor vehicle 200 may include a direction of orientation 205, front seats 210a and 210b (collectively, “front seats 210”), back seat 215, passengers 220a, 220b, 220c, 220d, and 220e (collectively, “passengers 220”), right user speakers 225, and left user speakers 230, which may be respectively similar to, and share one or more characteristics with, direction of orientation 105, front seats 110a and 110b, back seat 115, passengers 120a, 120b, 120c, 120d, and 120e, right user speakers 125, and left user speakers 130. The right user speakers 225 may be configured to play a right audio signal 240a, 240b, and 240c (collectively, “right audio signals 240”), which may be similar to, and share one or more characteristics with, one or more of the right audio signals 140. The left user speakers 230 may be configured to play a left audio signal 245a, 245b, and 245c (collectively, “left audio signals 245”), which may be similar to, and share one or more characteristics with, one or more of the left audio signals 145. Finally, the motor vehicle 200 may include a virtualization speaker 250 which may be similar to, and share one or more characteristics with, virtualization speaker 150. The virtualization speaker 250 may be configured to emit one or more virtualization audio signals 235a, 235b, and 235c (collectively, “virtualization audio signals 235”), which may be similar to, and share one or more characteristics with, one or more of the virtualization audio signals 135. The motor vehicle 200 may further include a processor such as the processor described above with respect to FIG. 1. Similarly to FIG. 1, the processor is not depicted in FIG. 2 for the sake of elimination of clutter of the Figure.

As can be seen in FIG. 2, in some embodiments the virtualization speaker 250 may not be positioned along a center axis of the motor vehicle (as shown in, for example, FIG. 1). Rather, the virtualization speaker 250 may be positioned closer to one of the passengers (e.g., passenger 220b) than another of the passengers (e.g., passenger 220a). Additionally, in some embodiments the audio signal that each passenger 220 is listening to may be the same. In other words, the audio signals being played by one or more of the virtualization speaker 250, the right user speaker 225, and the left user speaker 230 may each include the same content.

In this embodiment, it may be recognized that the virtualization audio signal 235b may reach passenger 220b before the virtualization audio signal 235a may reach passenger 220a. Similarly, the virtualization audio signal 235c may reach passenger 220d after both of the virtualization audio signals 235a and 235b reach passengers 220a and 220b, respectively.

Because various of the virtualization audio signals 235 may reach various of the passengers 220 at different times, it may be desirable to alter the time delay of the audio played by the right and left user speakers 225 and 230 with respect to the playback of one or more of the virtualization audio signals 235. For example, playback of the right and left audio signals 240a and 245a may be delayed with respect to the playback of the virtualization audio signal 235a by a greater time period than the delay of the playback of the right and left audio signals 240b and 245b with respect to the playback of the virtualization audio signal 235b. Playback of the right and left audio signals 240c and 245c may be even further delayed with respect to the playback of the virtualization audio signal 235c.

These different time periods of delays could be performed in different ways. In one embodiment, each of the virtualization audio signals 235 could be played generally concurrently with one another and the playback from the various right and left user speakers 225 and 230 could be delayed using different time periods so that the audio played by the right and left user speakers 225 and 230 was generally staggered.

However, in other embodiments it may be desirable to generally play the audio from the right and left user speakers 225 and 230 generally concurrently with one another, particularly if the right and left audio signals 240 and 245 are louder than the virtualization audio signals 235. Therefore, in these embodiments the right and left audio signals 240 and 245 may be played generally concurrently with one another, and the virtualization audio signals 235a, 235b, and 235c may be staggered with respect to one another.

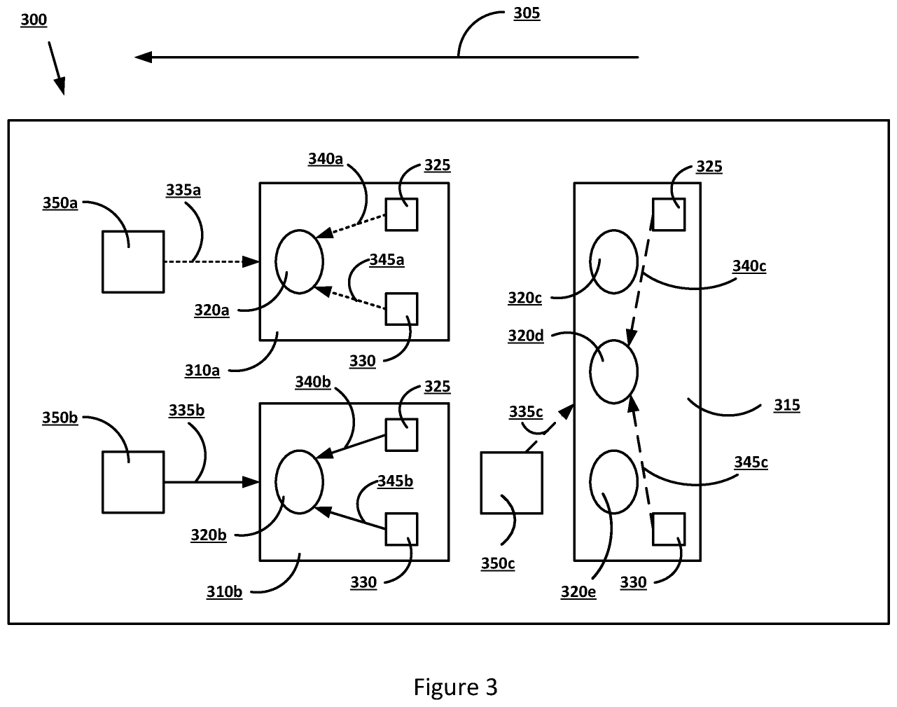

FIG. 3 depicts an alternative example configuration of a motor vehicle with an audio system that includes a virtualization speaker, in accordance with various embodiments. Generally, the motor vehicle 300 may be similar to, and share one or more characteristics with, motor vehicle 100. Specifically, the motor vehicle 300 may include a direction of orientation 305, front seats 310a and 310b (collectively, “front seats 310”), back seat 315, passengers 320a, 320b, 320c, 320d, and 320e (collectively, “passengers 320”), right user speakers 325, and left user speakers 330, which may be respectively similar to, and share one or more characteristics with, direction of orientation 105, front seats 110a and 110b, back seat 115, passengers 120a, 120b, 120c, 120d, and 120e, right user speakers 125, and left user speakers 130. The right user speakers 325 may be configured to play a right audio signal 340a, 340b, and 340c (collectively, “right audio signals 340”), which may be similar to, and share one or more characteristics with, one or more of the right audio signals 140. The left user speakers 330 may be configured to play a left audio signal 345a, 345b, and 345c (collectively, “left audio signals 345”), which may be similar to, and share one or more characteristics with, one or more of the left audio signals 145. The motor vehicle 300 may further include a processor such as the processor described above with respect to FIG. 1. Similarly to FIG. 1, the processor is not depicted in FIG. 3 for the sake of elimination of clutter of the Figure.

The motor vehicle 300 may further include a plurality of virtualization speakers 350a, 350b, and 350c (collectively, “virtualization speakers 350”). Respective ones of the virtualization speakers 350 may be similar to, and share one or more characteristics with, virtualization speaker 150. The virtualization speakers 350a, 350b, and 350c may be respectively configured to play virtualization audio signals 335a, 335b, and 335c and shown in FIG. 3.

More specifically, in this embodiment the motor vehicle 300 may have a plurality of virtualization speakers 350. There may be a virtualization speaker 350a and 350b for each of the front seats 310a and 310b, and another virtualization speaker 350c for the back seat 315.

As previously noted, it will be understood that the embodiments of FIGS. 1-3 are intended as non-exclusive example embodiments and other embodiments may have one or more variations from the embodiments of FIGS. 1-3, or may combine aspects of the various Figures.

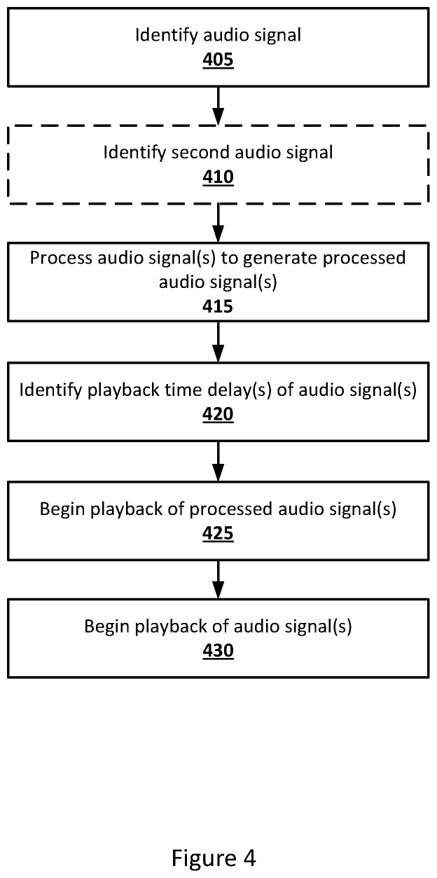

FIG. 4 depicts an example technique which may be used in or by an audio system with a virtualization speaker (e.g., virtualization speaker 150), in accordance with various embodiments. For the sake of discussion herein, FIG. 4 will be discussed with respect to elements of FIG. 1. However, it will be understood that FIG. 4 may, in whole or in part, with or without modification, be appropriately used by an audio system of a motor vehicle in accordance with other embodiments herein. Generally, the technique may be performed by the processor(s) discussed above with respect to FIGS. 1-3.

The technique may include identifying, at 405, an audio signal. The audio signal may be, for example, a song or some other type of audio signal that is to be played back by speakers of the motor vehicle. Specifically, the audio signal may be an audio signal that is to be played by right and left user speakers such as speakers 125 and 130.

Optionally, the technique may further include identifying, at 410, a second audio signal. In some embodiments the second audio signal may be, for example, an additional song which may be played back concurrently with the first audio signal as described above with respect to FIG. 1. In other embodiments, the second audio signal may be an audio signal that is generally identical to the first audio signal of 405, but requires different timing based on a difference in lengths of the audio path as described above with respect to, for example, FIG. 2.

The technique may further include processing, at 415, the audio signal(s) identified at 405 and (optionally) 410 to generate processed audio signal(s). The processed audio signal(s) may be, or may be related to, the virtualization signal(s) played by a virtualization signal such as virtualization speaker 150. Processing the audio signal(s) may include aspects such as high-pass filtering to isolate the high-frequency component(s) of the audio signal(s). Processing may additionally or alternatively include adjusting the volume of the audio signal(s) to raise or lower the relative volume of the resultant processed audio signal(s).

The technique may further include identifying, at 420, playback time delay(s) of the audio signal(s) from 405 and (optionally) 410 with respect to the processed audio signal(s) from 415. As previously described, it may be desirable for playback of the virtualization signal(s) to precede playback of the user audio signals so that a passenger of the motor vehicle perceives the overall audio signal as coming from in front of them. Therefore, the playback time delay of the audio signal(s) may be calculated with respect to the virtualization signal(s).

The technique may further include beginning, at 425, playback of the processed audio signal(s). Specifically, the technique may include beginning playback of the virtualization signal(s) 135 from the virtualization speaker 150. The technique may further include beginning, at 430, playback of the audio signal(s). Playback of the audio signal(s) may be in accordance with the time delay(s) calculated at 420 and may be, for example, the right and left audio signals 140 and 145 played from the right and left user speakers 125 and 130 as described above.

As previously noted, in some embodiments a virtualization signal may be the result of applying high-pass filtering to an audio signal. However, it may not always be the case that an audio signal has sufficient high-frequency components. This may be caused by, for example, a low bitrate of the audio signal. Therefore, it may be desirable to introduce high-frequency components to the audio signal such that the high-pass filter may produce a processed audio signal with sufficient data for playback.

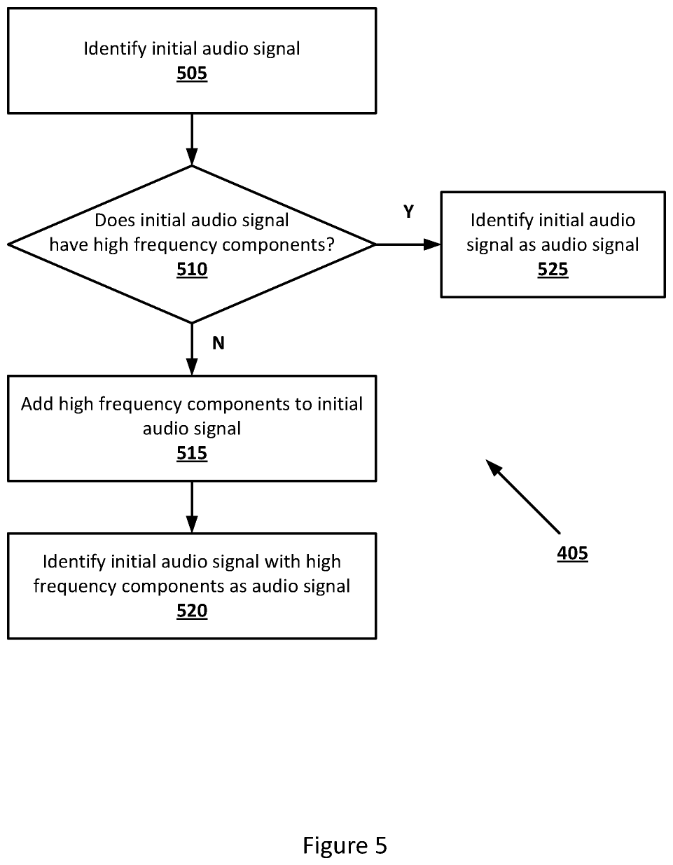

FIG. 5 depicts another technique which may be used in or by an audio system with a virtualization speaker, in accordance with various embodiments. Specifically, FIG. 5 may depict a more detailed view of element 405 of FIG. 4 wherein the audio signal may be analyzed to identify whether it includes sufficient high-frequency components for subsequent processing, or whether such components may need to be added. It will be understood that although FIG. 5 is described with respect to element 405, in other embodiments FIG. 5 may be, or may be a part of or related to, element 410 of FIG. 4.

The technique of FIG. 5 may include identifying, at 505, an initial audio signal. The initial audio signal may be the audio signal that is identified as being the audio signal to be played back. The audio signal may be, for example, a radio signal or an audio filed stored on a non-transitory computer-readable media such as a digital file or a song being read from a compact disc (CD).

The technique may further include identifying, at 510, whether the initial audio signal has high-frequency components. Specifically, the technique may include identifying, at 510, whether the initial audio signal has sufficient high-frequency components such that performing high-pass filtering of the initial audio signal may provide a virtualization signal with sufficient audio components such that playback of the virtualization signal may provide the desired perception that the signal is originating from in front of a user. This identification may be based on, for example, comparing the initial audio signal (or high-frequency components of the initial audio signal) with a pre-identified threshold or profile, or through some other comparison or identification. If the initial audio signal is identified at 510 as including sufficient high-frequency components, then the initial audio signal may be identified at 525 as the audio signal that is to be processed at 415 and played back at 430.

However, if the initial audio signal is identified at 510 as not including sufficient high-frequency components, then high-frequency components may be added to the initial audio signal at 515, and the initial audio signal with the added high-frequency components may be identified at 520 as the audio signal that is to be processed at 415 and played back at 430. Adding the high-frequency components may include techniques such as emphasizing or frequency-shifting existing frequencies of the initial audio signal, introducing randomized high-frequency components to the initial audio signal, or introducing a pre-identified pattern of high-frequency components to the initial audio signal. In some embodiments, the introduced high-frequency components may be above the range of human audio perception, so they may be relatively un-noticed by a passenger, however the high-frequency components in both the virtualization signal and the user audio signals may still be sufficient to cause a user to perceive the audio is originating from in front of them.

It will be understood that the techniques of FIGS. 4 and 5 are intended as simplified example techniques, and the techniques may vary in other embodiments. For example, some embodiments may include more or fewer elements than discussed with respect to FIG. 4 or 5. As one example, in some embodiments the technique of FIG. 5 may not be performed. In other embodiments, certain elements may be performed concurrently (e.g., elements 415 and 420) or in a different order than depicted. Other variations may be present in other embodiments.

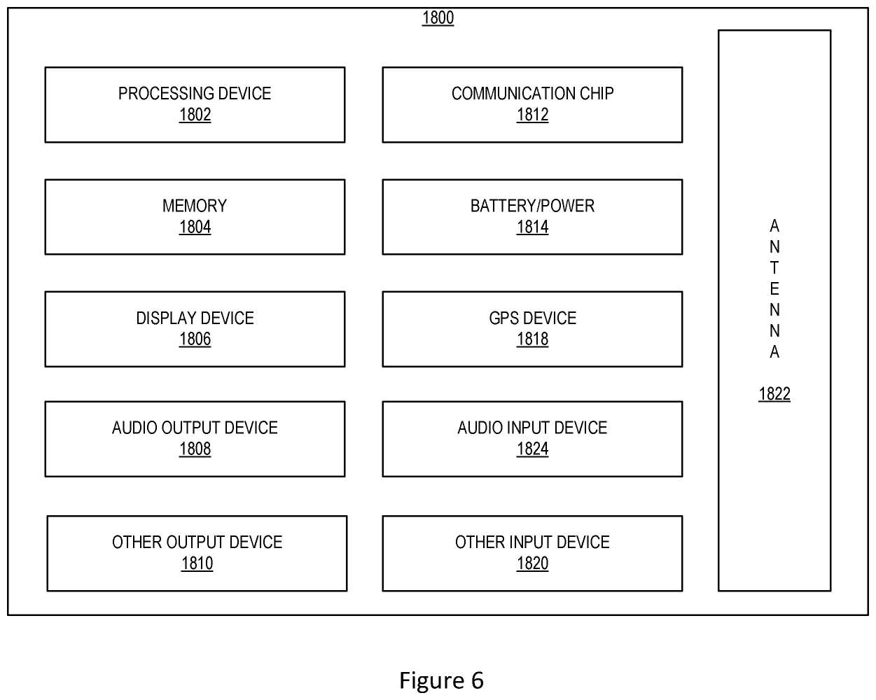

FIG. 6 is a block diagram of an example electrical device 1800 that may be included in one or more motor vehicles, or may be an element of an audio system of the one or more motor vehicles, in accordance with any of the embodiments disclosed herein. A number of components are illustrated in FIG. 6 as included in the electrical device 1800, but any one or more of these components may be omitted or duplicated, as suitable for the application. In some embodiments, some or all of the components included in the electrical device 1800 may be attached to one or more motherboards. In some embodiments, some or all of these components are fabricated onto a single system-on-a-chip (SoC) die.

Additionally, in various embodiments, the electrical device 1800 may not include one or more of the components illustrated in FIG. 6, but the electrical device 1800 may include interface circuitry for coupling to the one or more components. For example, the electrical device 1800 may not include a display device 1806, but may include display device interface circuitry (e.g., a connector and driver circuitry) to which a display device 1806 may be coupled. In another set of examples, the electrical device 1800 may not include an audio input device 1824 or an audio output device 1808, but may include audio input or output device interface circuitry (e.g., connectors and supporting circuitry) to which an audio input device 1824 or audio output device 1808 may be coupled.

The electrical device 1800 may include a processing device 1802 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1802 may include one or more digital signal processors (DSPs), application-specific integrated circuits (ASICs), CPUs, graphics processing units (GPUs), cryptoprocessors (specialized processors that execute cryptographic algorithms within hardware), server processors, or any other suitable processing devices. The electrical device 1800 may include a memory 1804, which may itself include one or more memory devices such as volatile memory (e.g., dynamic random-access memory (DRAM)), nonvolatile memory (e.g., read-only memory (ROM)), flash memory, solid state memory, and/or a hard drive. In some embodiments, the memory 1804 may include memory that shares a die with the processing device 1802. This memory may be used as cache memory and may include embedded dynamic random-access memory (eDRAM) or spin transfer torque magnetic random-access memory (STT-MRAM). In some embodiments, the processing device 1802 may be the processor that is described with respect to FIG. 1, 2, or 3.

In some embodiments, the electrical device 1800 may include a communication chip 1812 (e.g., one or more communication chips). For example, the communication chip 1812 may be configured for managing wireless communications for the transfer of data to and from the electrical device 1800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 1812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1812 may operate in accordance with other wireless protocols in other embodiments. The electrical device 1800 may include an antenna 1822 to facilitate wireless communications and/or to receive other wireless communications (such as AM or FM radio transmissions).

In some embodiments, the communication chip 1812 may manage wired communications, such as electrical, optical, or any other suitable communication protocols (e.g., the Ethernet). As noted above, the communication chip 1812 may include multiple communication chips. For instance, a first communication chip 1812 may be dedicated to shorter-range wireless communications such as Wi-Fi or Bluetooth, and a second communication chip 1812 may be dedicated to longer-range wireless communications such as global positioning system (GPS), EDGE, GPRS, CDMA, WiMAX, LTE, EV-DO, or others. In some embodiments, a first communication chip 1812 may be dedicated to wireless communications, and a second communication chip 1812 may be dedicated to wired communications.

The electrical device 1800 may include battery/power circuitry 1814. The battery/power circuitry 1814 may include one or more energy storage devices (e.g., batteries or capacitors) and/or circuitry for coupling components of the electrical device 1800 to an energy source separate from the electrical device 1800 (e.g., AC line power).

The electrical device 1800 may include a display device 1806 (or corresponding interface circuitry, as discussed above). The display device 1806 may include any visual indicators, such as a heads-up display, a computer monitor, a projector, a touchscreen display, a liquid crystal display (LCD), a light-emitting diode display, or a flat panel display.

The electrical device 1800 may include an audio output device 1808 (or corresponding interface circuitry, as discussed above). The audio output device 1808 may include any device that generates an audible indicator, such as speakers, headsets, or earbuds.

The electrical device 1800 may include an audio input device 1824 (or corresponding interface circuitry, as discussed above). The audio input device 1824 may include any device that generates a signal representative of a sound, such as microphones, microphone arrays, or digital instruments (e.g., instruments having a musical instrument digital interface (MIDI) output).

The electrical device 1800 may include a GPS device 1818 (or corresponding interface circuitry, as discussed above). The GPS device 1818 may be in communication with a satellite-based system and may receive a location of the electrical device 1800, as known in the art.

The electrical device 1800 may include another output device 1810 (or corresponding interface circuitry, as discussed above). Examples of the other output device 1810 may include an audio codec, a video codec, a printer, a wired or wireless transmitter for providing information to other devices, or an additional storage device.

The electrical device 1800 may include another input device 1820 (or corresponding interface circuitry, as discussed above). Examples of the other input device 1820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The electrical device 1800 may have any desired form factor, such as a handheld or mobile electrical device (e.g., a cell phone, a smart phone, a mobile internet device, a music player, a tablet computer, a laptop computer, a netbook computer, an ultrabook computer, a personal digital assistant (PDA), an ultra mobile personal computer, etc.), a desktop electrical device, a server device or other networked computing component, a printer, a scanner, a monitor, a set-top box, an entertainment control unit, a vehicle control unit, a digital camera, a digital video recorder, or a wearable electrical device. In some embodiments, the electrical device 1800 may be any other electronic device that processes data.

### EXAMPLES OF VARIOUS EMBODIMENTS

Example 1 includes an audio system for playback of an audio signal, wherein the audio system comprises: a virtualization speaker located in a position that would be in front of a listener of the audio system; a user speaker located in a position that would be behind a listener of the audio system; and a processor coupled with the virtualization speaker and the user speaker, wherein the processor is to: identify a stereo signal that is to be played by the user speaker; process the stereo signal to generate a processed stereo signal; and begin playback of the processed stereo signal from the virtualization speaker prior to beginning playback of the stereo signal from the user speaker.

Example 2 includes the audio system of example 1, or some other example herein, wherein the processor is to process the stereo signal by applying a high-pass filter to the stereo signal.

Example 3 includes the audio system of example 1, or some other example herein, wherein the processor is to process the stereo signal by decreasing the volume of the stereo signal.

Example 4 includes the audio system of any of examples 1-3, or some other example herein, wherein the virtualization speaker includes a single speaker.

Example 5 includes the audio system of any of examples 1-3, or some other example herein, wherein the virtualization speaker includes a plurality of speakers.

Example 6 includes the audio system of any of examples 1-3, or some other example herein, wherein the user speaker includes a set of stereo speakers.

Example 7 includes the audio system of any of examples 1-3, or some other example herein, wherein the audio system is an audio system of a motor vehicle.

Example 8 includes the audio system of any of examples 1-3, or some other example herein, wherein the processor is to begin playback of the processed stereo signal between 5 milliseconds (ms) and 10 ms prior to beginning playback of the stereo signal.

Example 9 includes the audio system of any of examples 1-3, or some other example herein, wherein the audio system further comprises a second user speaker located in a position that would be behind a second listener of the audio system, and the second user speaker is coupled with the processor, and wherein the processor is further to: identify a second stereo signal that is to be played by the second user speaker; process the second stereo signal to generate a second processed stereo signal; and begin playback of the second processed stereo signal from the virtualization speaker prior to beginning playback of the second stereo signal from the second user speaker, wherein playback of the processed stereo signal at least partially overlaps with playback of the second processed stereo signal.

Example 10 includes a motor vehicle with an audio system, wherein the audio system includes: a first user speaker located in a position that would be behind a first occupant of the motor vehicle, wherein the first user speaker is to play a first audio signal; a second user speaker located in a position that would be behind a second occupant of the motor vehicle, wherein the second user speaker is to play a second audio signal; and a virtualization speaker located in a position that would be in front of the first occupant and the second occupant, wherein the virtualization speaker is to: play a first processed audio signal that is related to the first audio signal; and play a second processed audio signal that is related to the second audio signal; wherein playback of the first processed audio signal at least partially overlaps playback of the second processed audio signal.

Example 11 includes the motor vehicle of example 10, or some other example herein, wherein the virtualization speaker is a single speaker.

Example 12 includes the motor vehicle of examples 10 or 11, or some other example herein, wherein the first processed audio signal is portions of the first audio signal with a frequency greater than 1 kilohertz (kHz).

Example 13 includes the motor vehicle of examples 10 or 11, or some other example herein, wherein playback of the first processed audio signal is at a volume lower than playback of the first audio signal.

Example 14 includes the motor vehicle of examples 10 or 11, or some other example herein, wherein playback of the first audio signal is to begin between 5 milliseconds (ms) and 40 ms after playback of the first processed audio signal begins.

Example 15 includes one or more non-transitory computer-readable media comprising instructions that, upon execution by a processor of an audio system of a motor vehicle, are to cause the processor to: identify a stereo signal that is to be played by a user speaker at a location behind an occupant of the motor vehicle; perform high-pass filtering of the stereo signal to generate a processed stereo signal; begin playback of the processed stereo signal from a virtualization speaker at a location in front of an occupant of the motor vehicle; and subsequent to beginning playback of the processed stereo signal, begin playback of the stereo signal from the user speaker.

Example 16 includes the one or more non-transitory computer-readable media of example 15, or some other example herein, wherein the instructions to perform high-pass filtering include instructions to remove frequencies lower than 1 kilohertz (kHz) from the stereo signal to generate the processed stereo signal.

Example 17 includes the one or more non-transitory computer-readable media of examples 15 or 16, or some other example herein, wherein the instructions are further to begin playback of the processed stereo signal at a lower volume than playback of the stereo signal.

Example 18 the one or more non-transitory computer-readable media of examples 15 or 16, or some other example herein, wherein playback of the stereo signal is to begin less than 40 milliseconds (ms) after beginning playback of the processed stereo signal.

Example 19 includes the one or more non-transitory computer-readable media of examples 15 or 16, or some other example herein, wherein the instructions are to begin playback of the stereo signal at a time such that the stereo signal arrives at the occupant between 5 milliseconds (ms) and 10 ms after he processed stereo signal arrives at the occupant.

Example 20 includes the one or more non-transitory computer-readable media of examples 15 or 16, or some other example herein, wherein the instructions are further to: identify a second stereo signal that is to be played by a second user speaker at a location behind a second occupant of the motor vehicle; perform high-pass filtering of the second stereo signal to generate a second processed stereo signal; begin playback of the second processed stereo signal from the virtualization speaker; subsequent to beginning playback of the second processed stereo signal, begin playback of the second stereo signal from the second user speaker; wherein playback of the processed stereo signal and the second processed stereo signal at least partially overlap; and wherein playback of the stereo signal and the second stereo signal at least partially overlap.

Example 21 may include an apparatus comprising means to perform all or part of a process flow, technique, or method related to any of examples 1-20, or some other example herein.

Example 22 may include a method related to all or part of a process flow, technique, or method related to any of examples 1-20, or some other example herein.

Example 23 may include one or more non-transitory computer-readable media comprising instructions that, upon execution of the instructions by an element of an electronic device, are to cause the electronic device or perform all or part of a process flow, technique, or method related to any of examples 1-20, or some other example herein.

Example 24 may include an apparatus comprising physical structures such as speakers, processors, etc. related to any of examples 1-20, or some other example herein.

Example 25 may include an apparatus comprising structures configured to perform all or part of a process flow, technique, or method related to any of examples 1-20, or some other example herein.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or limiting as to the precise forms disclosed. While specific implementations of, and examples for, various embodiments or concepts are described herein for illustrative purposes, various equivalent modifications may be possible, as those skilled in the relevant art will recognize. These modifications may be made in light of the above detailed description, the Abstract, the Figures, or the claims.

1. An audio system for playback of an audio signal, wherein the audio system comprises:
a virtualization speaker located in a position that would be in front of a listener of the audio system;
a user speaker located in a position that would be behind a listener of the audio system; and
a processor coupled with the virtualization speaker and the user speaker, wherein the processor is to:
identify a stereo signal that is to be played by the user speaker;
process the stereo signal to generate a processed stereo signal; and
begin playback of the processed stereo signal from the virtualization speaker prior to beginning playback of the stereo signal from the user speaker.

2. The audio system of claim 1, wherein the processor is to process the stereo signal by applying a high-pass filter to the stereo signal.

3. The audio system of claim 1, wherein the processor is to process the stereo signal by decreasing volume of the stereo signal.

4. The audio system of claim 1, wherein the virtualization speaker includes a single speaker.

5. The audio system of claim 1, wherein the virtualization speaker includes a plurality of speakers.

6. The audio system of claim 1, wherein the user speaker includes a set of stereo speakers.

7. The audio system of claim 1, wherein the audio system is an audio system of a motor vehicle.

8. The audio system of claim 1, wherein the processor is to begin playback of the processed stereo signal between 5 milliseconds (ms) and 10 ms prior to beginning playback of the stereo signal.

9. The audio system of claim 1, wherein the audio system further comprises a second user speaker located in a position that would be behind a second listener of the audio system, and the second user speaker is coupled with the processor, and wherein the processor is further to:
identify a second stereo signal that is to be played by the second user speaker;
process the second stereo signal to generate a second processed stereo signal; and
begin playback of the second processed stereo signal from the virtualization speaker prior to beginning playback of the second stereo signal from the second user speaker, wherein playback of the processed stereo signal at least partially overlaps with playback of the second processed stereo signal.

10. A motor vehicle with an audio system, wherein the audio system includes:
a first user speaker located in a position that would be behind a first occupant of the motor vehicle, wherein the first user speaker is to play a first audio signal;
a second user speaker located in a position that would be behind a second occupant of the motor vehicle, wherein the second user speaker is to play a second audio signal; and
a virtualization speaker located in a position that would be in front of the first occupant and the second occupant, wherein the virtualization speaker is to:
play a first processed audio signal that is related to the first audio signal; and
play a second processed audio signal that is related to the second audio signal;
wherein playback of the first processed audio signal at least partially overlaps playback of the second processed audio signal.

11. The motor vehicle of claim 10, wherein the virtualization speaker is a single speaker.

12. The motor vehicle of claim 10, wherein the first processed audio signal is portions of the first audio signal with a frequency greater than 1 kilohertz (kHz).

13. The motor vehicle of claim 10, wherein playback of the first processed audio signal is at a volume lower than playback of the first audio signal.

14. The motor vehicle of claim 10, wherein playback of the first audio signal is to begin between 5 milliseconds (ms) and 40 ms after playback of the first processed audio signal begins.

15. One or more non-transitory computer-readable media comprising instructions that, upon execution by a processor of an audio system of a motor vehicle, are to cause the processor to:
identify a stereo signal that is to be played by a user speaker at a location behind an occupant of the motor vehicle;
perform high-pass filtering of the stereo signal to generate a processed stereo signal;
begin playback of the processed stereo signal from a virtualization speaker at a location in front of an occupant of the motor vehicle; and
subsequent to beginning playback of the processed stereo signal, begin playback of the stereo signal from the user speaker.

16. The one or more non-transitory computer-readable media of claim 15, wherein the instructions to perform high-pass filtering include instructions to remove frequencies lower than 1 kilohertz (kHz) from the stereo signal to generate the processed stereo signal.

17. The one or more non-transitory computer-readable media of claim 15, wherein the instructions are further to begin playback of the processed stereo signal at a lower volume than playback of the stereo signal.

18. The one or more non-transitory computer-readable media of claim 15, wherein playback of the stereo signal is to begin less than 40 milliseconds (ms) after beginning playback of the processed stereo signal.

19. The one or more non-transitory computer-readable media of claim 15, wherein the instructions are to begin playback of the stereo signal at a time such that the stereo signal arrives at the occupant between 5 milliseconds (ms) and 10 ms after he processed stereo signal arrives at the occupant.

20. The one or more non-transitory computer-readable media of claim 15, wherein the instructions are further to:
identify a second stereo signal that is to be played by a second user speaker at a location behind a second occupant of the motor vehicle;
perform high-pass filtering of the second stereo signal to generate a second processed stereo signal;
begin playback of the second processed stereo signal from the virtualization speaker;
subsequent to beginning playback of the second processed stereo signal, begin playback of the second stereo signal from the second user speaker;
wherein playback of the processed stereo signal and the second processed stereo signal at least partially overlap; and
wherein playback of the stereo signal and the second stereo signal at least partially overlap.
